(19) United States
(12) Patent Application Publication
(10) Pub. No.: US 2019/0354998 A1
(43) Pub. Date: Nov. 21, 2019

(54) SYSTEM AND METHOD FOR GENERATING A STANDARDIZED HIERARCHY OF COMPONENTS

(71) Applicant: ACTIO Analytics Inc., Tampa, FL (US)

(72) Inventors: Kevin MacNeill, Ottawa Ontario (CA); John S. Simon, JR., Marietta, GA (US)

(21) Appl. No.: 16/416,755

(22) Filed: May 20, 2019

Related U.S. Application Data
(60) Provisional application No. 62/673,567, filed on May 18, 2018.

(51) Int. Cl. G06Q 30/02; G06Q 20/20; G06Q 50/12; G06Q 10/06

(52) U.S. Cl. CPC G06Q 30/0201; G06Q 20/202; G06Q 10/087; G06Q 10/0637; G06Q 10/06395; G06Q 50/12

(57) ABSTRACT

A method, computer program product, and computer system for receiving, via a computing device, transaction data associated with a plurality of distinct point-of-sale systems. The transaction data from the plurality of distinct point-of-sale systems may be mapped to a standardized hierarchy of components. The standardized hierarchy of components, including aggregated mapped transaction data, may be shared.

### CROSS-REFERENCE TO RELATED APPLICATIONS

This application claims the benefit of U.S. Provisional Application No. 62/673,567, filed on 18 May 2018, the contents of which are incorporated by reference.

### BACKGROUND

Business intelligence and analytics continues to be a fast-growing area of interest. Current solutions are complex because they include multiple entities, data sets, different software applications, differences in processing cycles, added customization, and the need for professional services.

Recently solutions have moved from onsite storage systems to cloud-based storage systems. Cloud-based storage offers several advantages over onsite storage systems including reduced cost and ease of access to most recent software application updates. However, both onsite storage systems and cloud-based storage systems require various skill sets to set up, implement, and operate. Further, many companies (e.g., small businesses, larger corporations, etc.) may utilize distinct storage systems that may not be able to share data with other storage systems.

### BRIEF SUMMARY OF DISCLOSURE

In one example implementation, a method, performed by one or more computing devices, may include but is not limited to receiving, via a computing device, transaction data associated with a plurality of distinct point-of-sale systems. The transaction data from the plurality of distinct point-of-sale systems may be mapped to a standardized hierarchy of components. The standardized hierarchy of components, including aggregated mapped transaction data, may be shared.

One or more of the following example features may be included. Attribute information associated with the transaction data may be received. Mapping the transaction data from the plurality of distinct point-of-sale systems to a standardized hierarchy of components may include at least one of: performing correlation analysis of the transaction data to determine one or more patterns between components; and performing textual analysis of the transaction data to determine similar components from the transaction data of the plurality of distinct point-of-sales systems based upon, at least in part, text of the transaction data. Mapping the transaction data from the plurality of distinct point-of-sale systems to the standardized hierarchy of components may include generating a unique identifier for each component in the standardized hierarchy of components. Mapping the transaction data from the plurality of distinct point-of-sale systems to the standardized hierarchy of components may include determining that a portion of the transaction data cannot be mapped to the standardized hierarchy of components; generating an error indicating that the at least a portion of the transaction data cannot be mapped to the standardized hierarchy of components; receiving a user-defined mapping for the at least a portion of the transaction data; mapping the at least a portion of the transaction data to the standardized hierarchy of components based upon, at least in part, the user-defined mapping; and incorporating the user-defined mapping into the standardized hierarchy of components.

Mapping the transaction data from the plurality of distinct point-of-sale systems to the standardized hierarchy of components may include generating a list of component pairings based upon, at least in part, the mapped transaction data of the standardized hierarchy of components. Mapping the transaction data from the plurality of distinct point-of-sale systems to the standardized hierarchy of components may include generating a list of links between one or more components and one or more cross-brand components based upon, at least in part, the mapped transaction data of the standardized hierarchy of components. Mapping the transaction data from the plurality of distinct point-of-sale systems to the standardized hierarchy of components may include generating a plurality of catalogs based upon, at least in part, the mapped transaction data of the standardized hierarchy of components. Sharing the standardized hierarchy of components, including the aggregated mapped transaction data, may include sharing the standardized hierarchy of components, including the aggregated mapped transaction data, with at least one of: one or more performance reporting systems; one or more ordering systems; one or more inventory systems; and one or more delivery systems. Sharing the standardized hierarchy of components, including the aggregated mapped transaction data, may include converting the aggregated mapped transaction data of the standardized hierarchy of components into one or more recipient-specific formats. The plurality of distinct point-of-sale systems may be associated with a plurality of distinct eating and drinking businesses and the standardized hierarchy of components may be a hierarchy of components associated with the plurality of distinct eating and drinking businesses.

In another example implementation, a computing system may include one or more processors and one or more memories configured to perform operations that may include but are not limited to receiving transaction data associated with a plurality of distinct point-of-sale systems. The transaction data from the plurality of distinct point-of-sale systems may be mapped to a standardized hierarchy of components. The standardized hierarchy of components, including aggregated mapped transaction data, may be shared.

One or more of the following example features may be included. Attribute information associated with the transaction data may be received. Mapping the transaction data from the plurality of distinct point-of-sale systems to a standardized hierarchy of components may include at least one of: performing correlation analysis of the transaction data to determine one or more patterns between components; and performing textual analysis of the transaction data to determine similar components from the transaction data of the plurality of distinct point-of-sales systems based upon, at least in part, text of the transaction data. Mapping the transaction data from the plurality of distinct point-of-sale systems to the standardized hierarchy of components may include generating a unique identifier for each component in the standardized hierarchy of components. Mapping the transaction data from the plurality of distinct point-of-sale systems to the standardized hierarchy of components may include determining that a portion of the transaction data cannot be mapped to the standardized hierarchy of components; generating an error indicating that the at least a portion of the transaction data cannot be mapped to the standardized hierarchy of components; receiving a user-defined mapping for the at least a portion of the transaction data; mapping the at least a portion of the transaction data to the standardized hierarchy of components based upon, at least in part, the user-defined mapping; and incorporating the user-defined mapping into the standardized hierarchy of components.

Mapping the transaction data from the plurality of distinct point-of-sale systems to the standardized hierarchy of components may include generating a list of component pairings based upon, at least in part, the mapped transaction data of the standardized hierarchy of components. Mapping the transaction data from the plurality of distinct point-of-sale systems to the standardized hierarchy of components may include generating a list of links between one or more brand components and one or more cross-brand components based upon, at least in part, the mapped transaction data of the standardized hierarchy of components. Mapping the transaction data from the plurality of distinct point-of-sale systems to the standardized hierarchy of components may include generating a plurality of catalogs based upon, at least in part, the mapped transaction data of the standardized hierarchy of components. Sharing the standardized hierarchy of components, including the aggregated mapped transaction data, may include sharing the standardized hierarchy of components, including the aggregated mapped transaction data, with at least one of: one or more performance reporting systems; one or more ordering systems; one or more inventory systems; and one or more delivery systems. Sharing the standardized hierarchy of components, including the aggregated mapped transaction data, may include converting the aggregated mapped transaction data of the standardized hierarchy of components into one or more recipient-specific formats. The plurality of distinct point-of-sale systems may be associated with a plurality of distinct eating and drinking businesses and the standardized hierarchy of components may be a hierarchy of components associated with the plurality of distinct eating and drinking businesses.

In another example implementation, a computer program product may reside on a computer readable storage medium having a plurality of instructions stored thereon which, when executed across one or more processors, may cause at least a portion of the one or more processors to perform operations that may include but are not limited to receiving transaction data associated with a plurality of distinct point-of-sale systems. The transaction data from the plurality of distinct point-of-sale systems may be mapped to a standardized hierarchy of components. The standardized hierarchy of components, including aggregated mapped transaction data, may be shared.

One or more of the following example features may be included. Attribute information associated with the transaction data may be received. Mapping the transaction data from the plurality of distinct point-of-sale systems to a standardized hierarchy of components may include at least one of: performing correlation analysis of the transaction data to determine one or more patterns between components; and performing textual analysis of the transaction data to determine similar components from the transaction data of the plurality of distinct point-of-sales systems based upon, at least in part, text of the transaction data. Mapping the transaction data from the plurality of distinct point-of-sale systems to the standardized hierarchy of components may include generating a unique identifier for each component in the standardized hierarchy of components. Mapping the transaction data from the plurality of distinct point-of-sale systems to the standardized hierarchy of components may include determining that a portion of the transaction data cannot be mapped to the standardized hierarchy of components; generating an error indicating that the at least a portion of the transaction data cannot be mapped to the standardized hierarchy of components; receiving a user-defined mapping for the at least a portion of the transaction data; and mapping the at least a portion of the transaction data to the standardized hierarchy of components based upon, at least in part, the user-defined mapping.

Mapping the transaction data from the plurality of distinct point-of-sale systems to the standardized hierarchy of components may include generating a list of component pairings based upon, at least in part, the mapped transaction data of the standardized hierarchy of components. Mapping the transaction data from the plurality of distinct point-of-sale systems to the standardized hierarchy of components may include generating a list of links between one or more brand components and one or more cross-brand components based upon, at least in part, the mapped transaction data of the standardized hierarchy of components. Mapping the transaction data from the plurality of distinct point-of-sale systems to the standardized hierarchy of components may include generating a plurality of catalogs based upon, at least in part, the mapped transaction data of the standardized hierarchy of components. Sharing the standardized hierarchy of components, including the aggregated mapped transaction data, may include sharing the standardized hierarchy of components, including the aggregated mapped transaction data, with at least one of: one or more performance reporting systems; one or more ordering systems; one or more inventory systems; and one or more delivery systems. Sharing the standardized hierarchy of components, including the aggregated mapped transaction data, may include converting the aggregated mapped transaction data of the standardized hierarchy of components into one or more recipient-specific formats. The plurality of distinct point-of-sale systems may be associated with a plurality of distinct eating and drinking businesses and the standardized hierarchy of components may be a hierarchy of components associated with the plurality of distinct eating and drinking businesses.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a standardized component hierarchy generation process coupled to an example distributed computing network according to one or more example implementations of the disclosure;

FIG. 2 is an example flowchart of a standardized component hierarchy generation process according to one or more example implementations of the disclosure;

FIG. 3 is an example diagrammatic view of a plurality of point-of-sale systems and a central repository according to one or more example implementations of the disclosure;

FIGS. 4-5 are example diagrammatic views of a standardized hierarchy of components according to one or more example implementations of the disclosure;

FIG. 6 is an example diagrammatic view of central repository sharing a standardized hierarchy of components, including aggregated mapped transaction data, according to one or more example implementations of the disclosure;

FIG. 7 is an example diagrammatic view of the conversion of mapped transaction data to one or more recipient-specific formats according to one or more example implementations of the disclosure; and

FIG. 8 is an example diagrammatic view of a computer of FIG. 1 according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

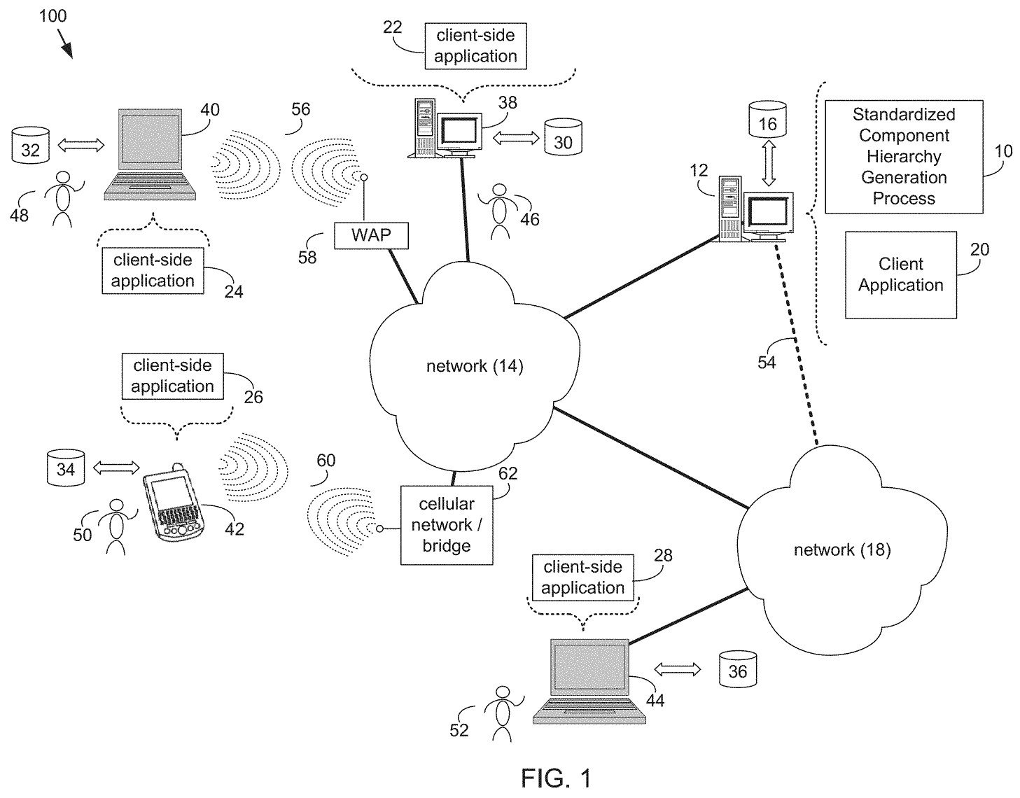

Referring now to the example implementation of FIG. 1, there is shown standardized component hierarchy generation process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a standardized component hierarchy generation process, such as standardized component hierarchy generation process 10 of FIG. 1, may include receiving, via a computing device, transaction data associated with a plurality of distinct point-of-sale systems. The transaction data from the plurality of distinct point-of-sale systems may be mapped to a standardized hierarchy of components. The standardized hierarchy of components, including aggregated mapped transaction data, may be shared.

In some implementations, the instruction sets and subroutines of standardized component hierarchy generation process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, standardized component hierarchy generation process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a client application (e.g., client application 20), examples of which may include, but are not limited to, e.g., point-of-sale applications/systems, performance reporting applications/systems, inventory applications/systems, delivery applications/systems, analytics applications/systems, ordering applications/systems, etc. In some implementations, standardized component hierarchy generation process 10 and/or client application 20 may be accessed via one or more of client-side applications 22, 24, 26, 28. In some implementations, standardized component hierarchy generation process 10 may be a standalone application, or may be an applet/application/script/extension that may interact with and/or be executed within client application 20, a component of client application 20, and/or one or more of client-side applications 22, 24, 26, 28. In some implementations, client application 20 may be a standalone application, or may be an applet/application/script/extension that may interact with and/or be executed within standardized component hierarchy generation process 10, a component of standardized component hierarchy generation process 10, and/or one or more of client-side applications 22, 24, 26, 28. In some implementations, one or more of client-side applications 22, 24, 26, 28 may be a standalone application, or may be an applet/application/script/extension that may interact with and/or be executed within and/or be a component of standardized component hierarchy generation process 10 and/or client application 20. Examples of client-side applications 22, 24, 26, 28 may include, but are not limited to, e.g., point-of-sale applications (e.g., executed by a point-of-sale terminal), performance reporting applications/systems, inventory applications/systems, delivery applications/systems, analytics applications/systems, ordering applications/systems, a standard and/or mobile web browser, an email application (e.g., an email client application), a textual and/or a graphical user interface, a customized web browser, a plugin, an Application Programming Interface (API), or a custom application. The instruction sets and subroutines of client-side applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a point-of-sale terminal (e.g., computing device used to process and record transactions), a server, a television, a smart television, a media (e.g., video, photo, etc.) capturing device, and a dedicated network device. In some implementations, each of client electronic devices 38, 40, 42, 44 may each execute a point-of-sale application/system for recording transactions. Accordingly and in some implementations, client devices 38, 40, 42, 44 may be considered point-of-sale terminals. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client-side applications 22, 24, 26, 28 may be configured to effectuate some or all of the functionality of standardized component hierarchy generation process 10 (and vice versa). Accordingly, in some implementations, standardized component hierarchy generation process 10 may be a purely server-side application, a purely client-side application, or a hybrid server-side/client-side application that is cooperatively executed by one or more of client-side applications 22, 24, 26, 28 and/or standardized component hierarchy generation process 10.

In some implementations, one or more of client-side applications 22, 24, 26, 28 may be configured to effectuate some or all of the functionality of client application 20 (and vice versa). Accordingly, in some implementations, client application 20 may be a purely server-side application, a purely client-side application, or a hybrid server-side/client-side application that is cooperatively executed by one or more of client-side applications 22, 24, 26, 28 and/or client application 20. As one or more of client-side applications 22, 24, 26, 28, standardized component hierarchy generation process 10, and client application 20, taken singly or in any combination, may effectuate some or all of the same functionality, any description of effectuating such functionality via one or more of client-side applications 22, 24, 26, 28, standardized component hierarchy generation process 10, client application 20, or combination thereof, and any described interaction(s) between one or more of client-side applications 22, 24, 26, 28, standardized component hierarchy generation process 10, client application 20, or combination thereof to effectuate such functionality, should be taken as an example only and not to limit the scope of the disclosure.

In some implementations, one or more of users 46, 48, 50, 52 may access computer 12 and standardized component hierarchy generation process 10 (e.g., using one or more of client electronic devices 38, 40, 42, 44) directly through network 14 or through secondary network 18. Further, computer 12 may be connected to network 14 through secondary network 18, as illustrated with phantom link line 54. Standardized component hierarchy generation process 10 may include one or more user interfaces, such as browsers and textual or graphical user interfaces, through which users 46, 48, 50, 52 may access standardized component hierarchy generation process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client-side applications 22, 24, 26, 28 to, e.g., computer 12. Examples of I/O request 15 may include but are not limited to, data write requests (e.g., a request that content be written to computer 12) and data read requests (e.g., a request that content be read from computer 12).

The Standardized Component Hierarchy Generation Process:

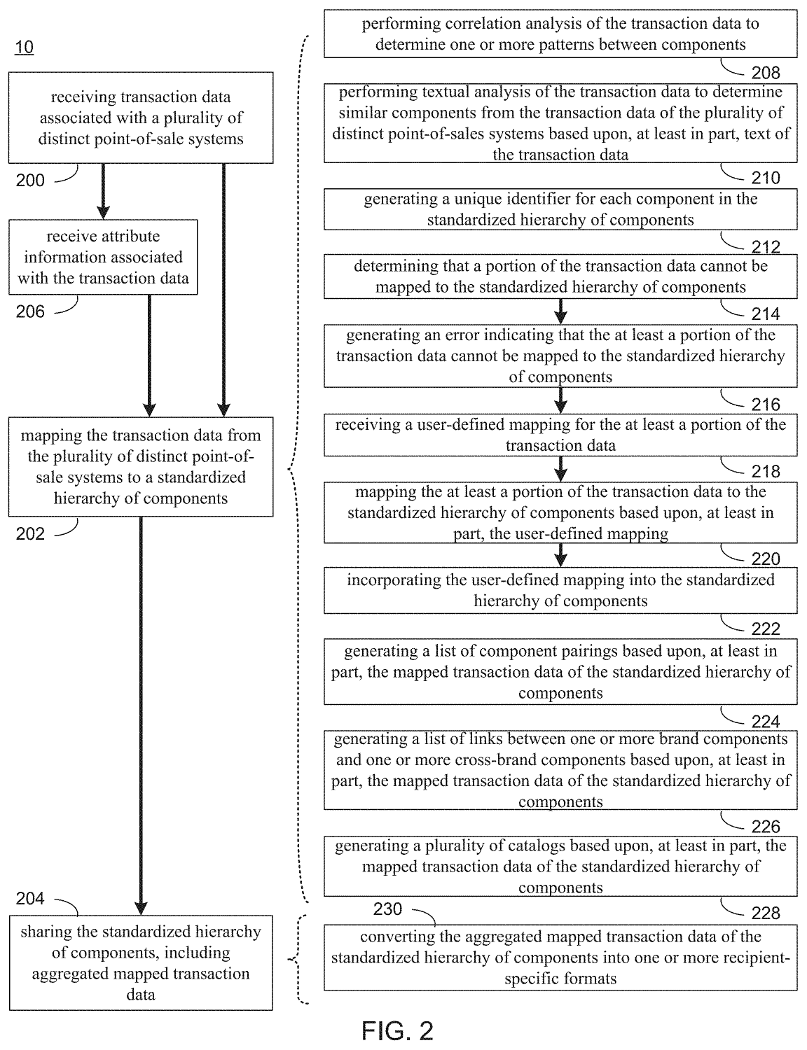

As discussed above and referring also at least to the example implementations of FIGS. 2-8, standardized component hierarchy generation process 10 may receive 200, via a computing device, transaction data associated with a plurality of distinct point-of-sale systems. The transaction data from the plurality of distinct point-of-sale systems may be mapped 202 to a standardized hierarchy of components. The standardized hierarchy of components, including aggregated mapped transaction data, may be shared 204.

As discussed above and in some implementations, business intelligence and analytics continues to be a fast-growing area of interest. Current solutions are complex because they include multiple data sets, different software applications, added customization, and the need for professional services. Recently solutions have moved from onsite storage systems to cloud-based storage systems. Cloud-based storage systems offer several advantages over onsite storage systems including, for example, reduced cost and ease of access to most recent software application updates. However, both onsite storage systems and cloud-based storage systems require various skill sets to set up, implement, and operate.

The result is a group of solutions that are growing in use but is not a viable solution for all companies. For example, a major drawback of these solutions is that they are limited to companies large enough to have a dedicated IT department, that has the necessary skill sets on how to collect the data sets, how to operate the various software applications and, how to select and work with professional services firm to set up, implement and operate the solution in up to real time company wide.

Therefore, a need exists for companies, that do not have sufficient budget or an IT department, to support a solution that allows the company to access a business intelligence and analytics solution that meets their specific needs which is easy to set up, simple to use, and affordable. Additionally, many businesses, even large corporations with dedicated IT departments, may store information in specialized or distinct formats or configurations within distinct storage systems that may not allow the data to be shared with others or understood by others. Accordingly, the inability for distinct systems used by various businesses to communicate may reduce the ability to understand data across various businesses, locations, etc.

The restaurant industry (e.g., eating and drinking business units/business units that purchase and/or sell food and drink) due to its unique business model is often not able to take advantage of current real time business intelligence and analytics solutions. There are several reasons why a solution for a multi-unit major retail brand will not typically work for a multi-unit major restaurant brand. In retail, the “brand” makes all technology decisions for the unit, whereas in the restaurant industry, the unit owner has ownership of some technology decisions. For example, in retail there is a standardized product list and symbology (e.g., UPC) that is understood by all stakeholders, whereas in restaurant industry there is generally no product table of any sort. Additionally, in retail the business model supports internal IT resources whereas in restaurants, at the unit level, there is often no budget for internal IT resources.

As will be discussed in greater detail below, embodiments of the present disclosure may provide real time business intelligence and analytics solutions for the restaurant industry, which may apply to other industries, that includes connecting to any point-of-sale (POS) system, building a standardized product table or hierarchy of components, connecting the POS and standardized hierarchy of components to other data sets, generating a library of key performance indicators (KPI's), displaying real time KPI's on a computing device, and providing the ability to customize the KPI's and the standardized hierarchy of components for specific users.

In some implementations, standardized component hierarchy generation process 10 may receive 200, via a computing device, transaction data associated with a plurality of distinct point-of-sale systems. Transaction data may generally include data associated with a transaction between a consumer and a unit or business (e.g., a sale of product(s) and/or service(s)). In some implementations, a “consumer” may generally include a person that purchases goods and/or services for personal use and a “unit” may generally include an individual thing or entity regarded as single and complete, but which can also form an individual component of a larger or more complex whole.

For example, transaction data may include, but is not limited to, information such as the date of a transaction, the location of the transaction, the time of the transaction, a register, (and if applicable) cashier or server, the product(s) and/or service(s) involved in the transaction, a quantity of product(s) and/or service(s), the price of the product and/or services, any applicable discounts, a subtotal, applicable taxes, a method of payment, credit or debit card numbers, a customer loyalty number, warranty information, contact information, a customer survey or a coupon, etc. A point-of-sale (POS) system may generally include an order input and transaction log for purchasing product(s) and/or service(s) from a unit. In some implementations, a POS system may include a system for recording online sales (e.g., using the Internet), telephonic sales, automated sales, sales at a retail establishment, a restaurant, etc. As such and in some implementations, it will be appreciated that a POS system may broadly refer to any transaction recording system regardless of the modality of purchasing products and/or services.

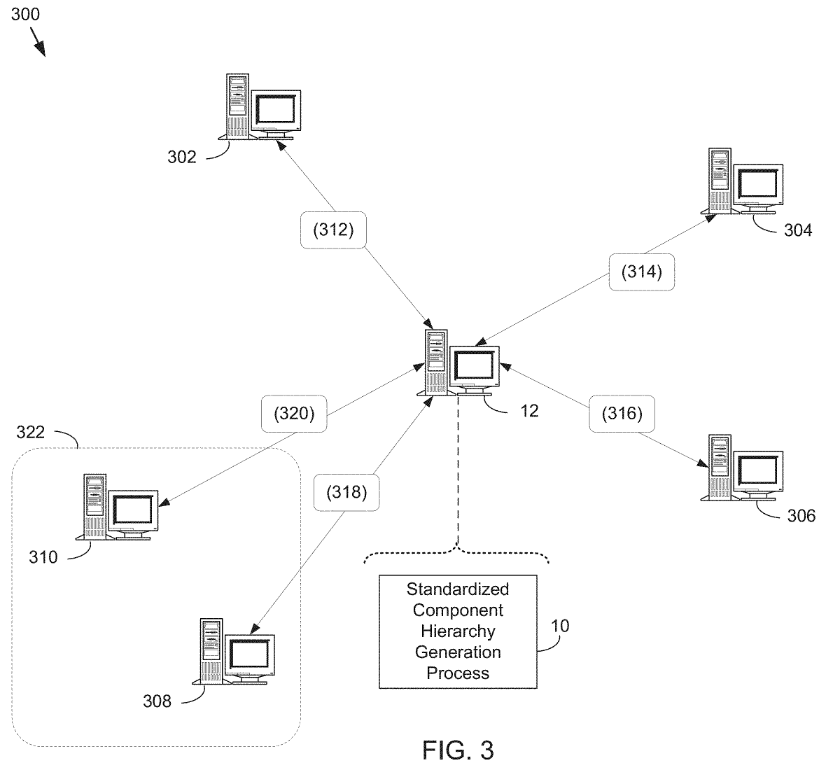

In some implementations, various units (e.g., businesses, individuals, etc.) may use distinct or unique point-of-sale systems to manage transaction data. In some implementations and as will be discussed in greater detail below, distinct point-of-sale systems may include distinct formats, taxonomies, descriptions, etc. for various products or services. Referring also to the example of FIG. 3 and in some implementations, a plurality of POS systems (e.g., POS systems 302, 304, 306, 308, 310) may record transactions associated with a particular unit (e.g., an eating and drinking business, a hotel, a hospital, etc.) and may generate transaction data associated with each POS system (e.g., transaction data 312, 314, 316, 318, 320). In some implementations, the transaction data associated with each POS system (e.g., transaction data 312, 314, 316, 318, 320) may be stored in the POS system (e.g., POS systems 302, 304, 306, 308, 310) and/or may be stored in one or more databases. For example and in some implementations, transaction data may be generated by a POS system and moved to a database for storage. As such, it will be appreciated that transaction data may be stored in the POS system and/or in a separate database. In some implementations, multiple POS systems may be associated with a common business (e.g., a franchise, a common business owner, etc.) with a common list of products and/or services. Accordingly, POS systems 308, 310 may be associated with a common business (e.g., common business 322) and may share a common set of products and/or services. In some implementations, POS systems 308, 310 may be identical.

In some implementations, POS systems 308, 310 may be unique. For example and in one example, POS systems 308, 310 may represent POS systems associated with a common business/franchise (e.g., common business 322) in different geographic regions (e.g., different parts of the United States of America, different countries, etc.). As such, POS systems 308, 310 may have one or more unique products and/or services. In some implementations and as will be discussed in greater detail below, the challenges associated with the distinctions between POS systems previously made comparison of products and/or services between units associated with the distinct POS systems generally prohibitive. Accordingly, embodiments of the present disclosure may provide a solution to map the transaction data (e.g., transaction data 312, 314, 316, 318, 320) to a standardized hierarchy of components.

In some implementations, receiving 200 transaction data may include providing an application or API configured to export POS transaction data from the plurality of POS systems and/or database(s) storing the transaction data associated with the plurality of POS systems. For example, computing device 12, as shown in FIG. 3, may provide an application or API to each of POS systems 302, 304, 306, 308, 310 to export transaction data to computing device 12. In some implementations, computing device 12 may be a “central repository” for transaction data. In some implementations, receiving 200 transaction data associated with the plurality of POS systems may include receiving the transaction data in one or more batches, in near real time, and/or in real time. For example, a “batch” may generally include a collection of a series of transactions accumulated for a predefined period of time before being transmitted. “Near real time” may generally include receiving 200 the transaction immediately after closing or completing a transaction; typically a few seconds after closing the transaction. “Real time” may generally include receiving 200 the transaction data while processing the transaction.

In some implementations, standardized component hierarchy generation process 10 may receive 206 attribute information associated with the transaction data. Attribute information may generally include various characteristics for components or items (e.g., products and/or services) that can be assigned at various levels and that may not be included in a product or service description. For example, attribute information for e.g., a food product may include whether the food product is e.g., fried, flame-grilled, frozen, refrigerated, or dry. In some implementations, attribute information may describe a menu associated with product and/or service (e.g., value menu of a restaurant, dessert menu of a restaurant, allergy menu (e.g., gluten-free, peanut-free, dairy-free, vegan, etc.), etc.). In some implementations, attribute information may describe a quality of the product or service (e.g., deluxe, custom, value, etc.). While some examples have been provided for attribute information, it will be appreciated that various attributes may be defined by various distinct POS systems.

In some implementations, attribute information may be received 206 with the transaction data. In some implementations and, as will be discussed in greater detail below, attribute information may be received 206 after at least a portion of transaction data from the plurality of distinct POS systems is mapped. In this manner, attribute information may be received 206 (e.g., added/updated) with and/or may be received independently of transaction data. In some implementations and as will be discussed in greater detail below, attribute information may be provided by a source of transaction data (e.g., a distinct POS system) and/or a recipient of the standardized hierarchy of components (e.g., a performance reporting system, an analytics application, an ordering application/system, an inventory application/system, a delivery application/system).

In some implementations and as will be discussed in greater detail below, in response to receiving attribute information, standardized component hierarchy generation process 10 may update mapped transaction data and/or the standardized hierarchy of components with the received attribute information. For example, suppose a user would like to determine how many products are e.g., “GMO-free”. In this example, the attribute “GMO-free” may be a new attribute and standardized component hierarchy generation process 10 may associate at least a portion of mapped data and/or at least a portion of the standardized hierarchy of components with the attribute e.g., “GMO-free”. In this example, one or more rules may be defined to qualify mapped transaction data and/or portions of the standardized hierarchy of components as being associated with the attribute e.g., “GMO-free”. Accordingly, standardized component hierarchy generation process 10 may associate mapped transaction data and/or portions of the standardized hierarchy of components with the attribute e.g., “GMO-free”. In some implementations, mapped transaction data may be re-mapped based upon, at least in part, the received attribute. For example, transaction data associated with “GMO-free” products may be mapped to a portion of standardized hierarchy of components associated with “GMO-free” products. While an example with a “GMO-free” attribute has been described, it will be appreciated that any attribute information may be received and added to the mapped transaction data and/or to the standardized hierarchy of components.

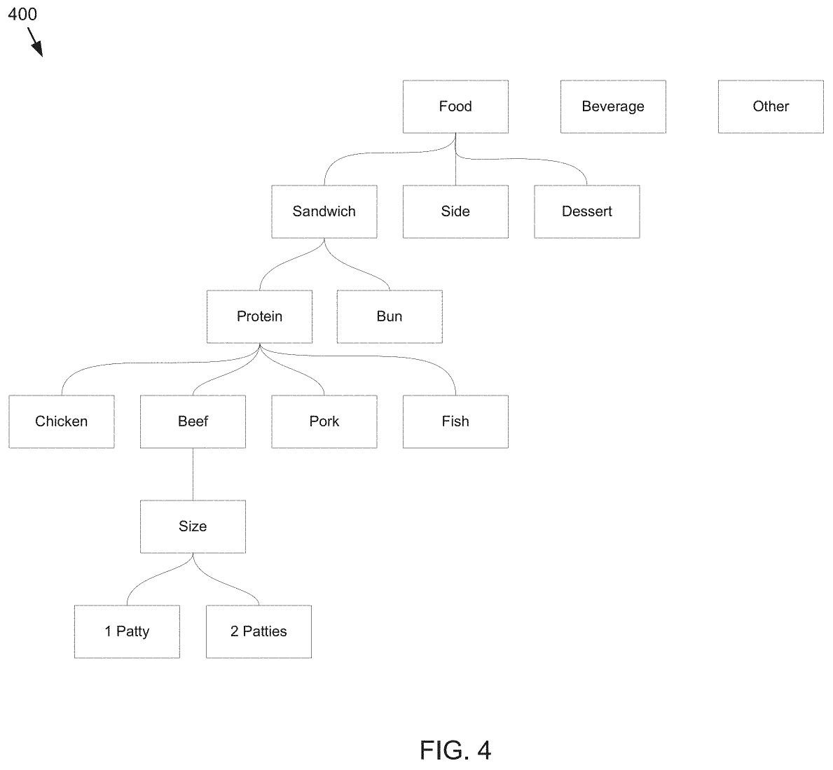

In some implementations, standardized component hierarchy generation process 10 may map 202 the transaction data from the plurality of distinct point-of-sale systems to a standardized hierarchy of components. A standardized hierarchy of components may generally include a data structure to organize and associate transaction data from the plurality of POS systems with one or more components or standard units. For example, a standard hierarchy of components may include any set of industry standard, third party, or proprietary standardized hierarchies, taxonomies, and/or catalogs of components. Referring also to the example of FIG. 4 and in some implementations, a standardized hierarchy of components (e.g., standardized hierarchy of components 400) is shown with various categories and sub-categories of various components. A component may generally include an individual atomic unit of a product or service and/or a hierarchical category/sub-category of individual atomic units of a product or service.

For example and as shown in FIG. 4, a standardized hierarchy of components may include various components (e.g., “Food”, “Beverage”, “Other”, “Sandwich”, “Side”, “Dessert”, “Protein”, Bun”, “Chicken”, “Beef”, “Pork”, “Fish”, “Size”, “1 Patty”, and “2 Patties”) organized in various categories and sub-categories. In this example, the standardized hierarchy of components (e.g., standardized hierarchy of components 400) may include a “Food” component/category which includes a “Sandwich” component, a “Side” component, and a “Dessert” component as sub-categories. The “Sandwich” component may include a “Protein” component and a “Bun” component. The “Protein” component may include a “Chicken” component, a “Beef” component, a “Pork” component, and a “Fish” component. In this example, the “Beef” component may include a Steak Burger “Size” component with a “1 Patty” component representative of a single beef patty of a beef sandwich and a “2 Patty” component representative of two beef patties of a beef sandwich. While FIG. 4 provides an example standardized hierarchy of components related to products of a restaurant/food service business, it will be appreciated that any standardized hierarchy of components may be used within the scope of the present disclosure, including any combination of products and/or services.

In some implementations, suppose transaction data 320 associated with POS system 310 includes transaction data for e.g., a purchase of a single patty hamburger at a restaurant. In this example, standardized component hierarchy generation process 10 may map 202 transaction data 320 to standardized hierarchy of components 400. For example and as will be discussed in greater detail below, portions of the transaction data may be interpreted by standardized component hierarchy generation process 10 to map the transaction data to one or more components of a standardized hierarchy. In this example, standardized component hierarchy generation process 10 may determine whether the single patty hamburger of transaction data 320 can be mapped to any component of e.g., a first category/first hierarchical level of a standardized hierarchy of components (e.g., standardized hierarchy of components 400). In this example and as will be discussed in greater detail below, standardized component hierarchy generation process 10 may map 202 a single patty hamburger to a “Food” component. Standardized component hierarchy generation process 10 may map 202 the single patty hamburger to one or more of the components/sub-categories (e.g., “Sandwich”, “Side”, and/or “Dessert”) of the “Food” component/category. In this example, standardized component hierarchy generation process 10 may map the single patty hamburger to a component “Protein” and a component “Bun”. As such, transaction data may be mapped to multiple components/categories/sub-categories of a standardized hierarchy of components.

Continuing with the above example and in some implementations, standardized component hierarchy generation process 10 may map 202 the single patty hamburger of transaction data 320 to a “Beef” component of the “Protein” category/sub-category/component and further may map 202 the single patty hamburger to a single patty component of the “Size” component in standardized hierarchy of components 400.

In some implementations, mapping 202 the transaction data from the plurality of distinct point-of-sale systems to a standardized hierarchy of components may include at least one of: performing 208 correlation analysis of the transaction data to determine one or more patterns between components and performing 210 textual analysis of the transaction data to determine similar components from the transaction data of the plurality of distinct point-of-sales systems based upon, at least in part, text of the transaction data. For example, standardized component hierarchy generation process 10 may perform 208 correlation analysis of the transaction data to determine one or more patterns between components. Correlation analysis may generally include automated statistical analysis (e.g., via a machine learning system, a neural network, or other artificial intelligence system) to determine patterns between items or components across time, location, and volume. For example and as will be discussed in greater detail below, standardized component hierarchy generation process 10 may perform 208 correlation analysis of the transaction data to determine a correlation between components. In one example, standardized component hierarchy generation process 10 may determine a correlation between the sale of two or more components. For example, transaction data may indicate, based on correlation analysis, that consumers are more likely to purchase e.g., orange soda when also purchasing e.g., a fish sandwich. While one example of a possible correlation between components has been provided, it will be appreciated that any number of or type of components may be correlated via correlation analysis performed 208 by standardized component hierarchy generation process 10.

In some implementations, standardized component hierarchy generation process 10 may map 202 transaction data to the standardized hierarchy of components by performing 210 textual analysis of the transaction data to determine similar components from the transaction data of the plurality of distinct point-of-sales systems based upon, at least in part, text of the transaction data. Textual analysis may generally include automated programs/systems configured to compare textual descriptions and/or numerical values associated with transaction data text (e.g., a textual description of transaction) to determine similar items and/or events. In some implementations, textual analysis may include processing, via a machine-learning system and/or a neural network, transaction data using, for example, optical character recognition (OCR), to identify text from the transaction data. The recognized transaction data text may be analyzed (e.g., via textual analysis) to determine a component associated with the transaction data text.

In some implementations and referring again to the above example where transaction data 320 includes e.g., a single patty hamburger, standardized component hierarchy generation process 10 may perform 210 textual analysis to compare a description of the single patty hamburger from transaction data 320 to map 202 the e.g., single patty hamburger to a “Food” component. Standardized component hierarchy generation process 10 may iteratively perform 210 textual analysis to map 202 the e.g., single patty hamburger to a “1 Patty” component in the example standardized hierarchy of components shown in FIG. 4. While an example has been provided of performing 210 textual analysis to map 202 the transaction data for a single patty hamburger, it will be appreciated that textual analysis may be performed 210 on any transaction data text to map 202 the transaction data to the standardized hierarchy of components.

In some implementations, mapping 202 the transaction data from the plurality of distinct point-of-sale systems to the standardized hierarchy of components may include generating 212 a unique identifier for each component in the standardized hierarchy of components. In some implementations and as discussed above, transaction data may be mapped to an industry standard standardized hierarchy of components, a third party standardized hierarchy of components, and/or a proprietary standardized hierarchy of components. In some implementations, standardized component hierarchy generation process 10 may map 202 the transaction data from the plurality of distinct POS systems to a plurality of standardized hierarchies of components. In some implementations, standardized component hierarchy generation process 10 may generate a standardized hierarchy of components with cross-references to components of other standardized hierarchies of components. Accordingly, standardized component hierarchy generation process 10 may generate 212 a unique identifier for each component in the generated standardized hierarchy of components. In some implementations, the unique identifier may be a unique alphanumerical expression associated with each component. However, it will be appreciated that any unique identifier may be generated within the scope of the present disclosure.

In some implementations, mapping 202 the transaction data from the plurality of distinct point-of-sale systems to the standardized hierarchy of components may include determining 214 that a portion of the transaction data cannot be mapped to the standardized hierarchy of components. For example, and referring again to the example of FIG. 3, suppose transaction data 316 is related to a newer item associated with POS system 306 (e.g., a stir fry entrée dish). In some implementations, standardized component hierarchy generation process 10 may attempt to map 202 transaction data 316 (e.g., related to a stir fry entrée dish) to a standardized hierarchy of components (e.g., standardized hierarchy of components 400). In this example, standardized component hierarchy generation process 10 may determine 214 that transaction data 316 cannot be mapped to the standardized hierarchy of components. For example, while a stir fry dish may be a food, standardized component hierarchy generation process 10 may be unable to map 202 the e.g., stir fry entrée dish to a “Sandwich” component, a “Side” component, and a “Dessert” component.

In some implementations, an error may be generated 216 indicating that the at least a portion of the transaction data cannot be mapped to the standardized hierarchy of components. In some implementations and continuing with the above example, standardized component hierarchy generation process 10 may generate 216 an error to alert a user of the inability to map the transaction data to the standardized hierarchy of components. In some implementations, the error may be displayed on a user interface.

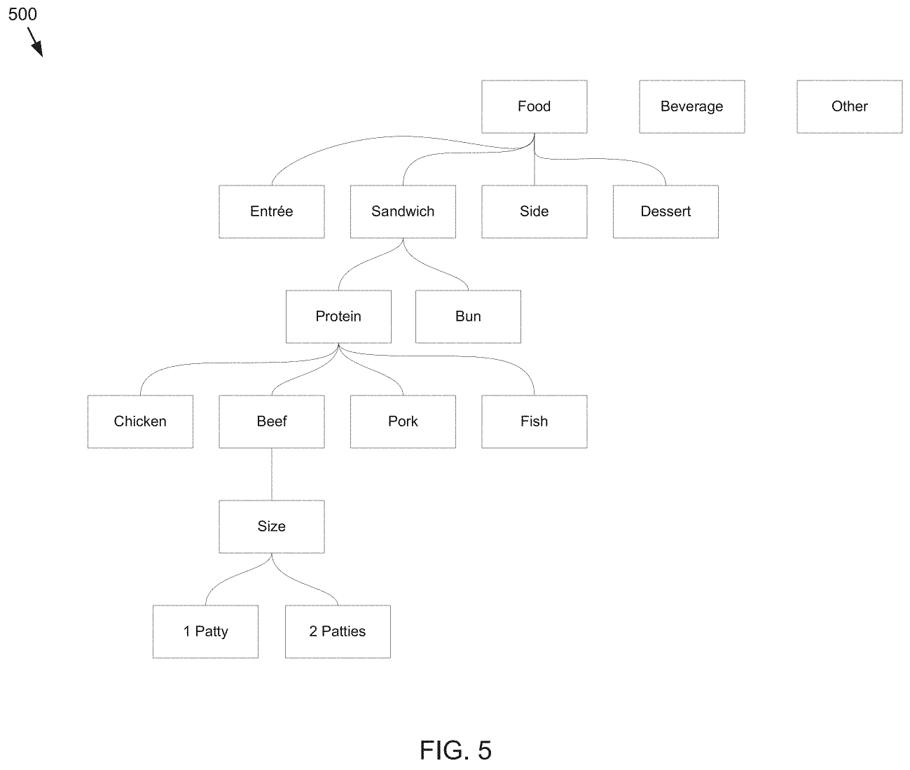

In some implementations, a user-defined mapping for the at least a portion of the transaction data may be received 218. For example and in response to the error, standardized component hierarchy generation process 10 may receive 218 a user-defined mapping. For example, a user may be prompted by standardized component hierarchy generation process 10 to define a mapping for the at least a portion of the transaction data. Accordingly, a user may provide (e.g., via a user-interface) a mapping of the at least a portion of the transaction data to an existing component/category/sub-category, a new component/category/sub-category, etc. In this example and as shown in FIG. 5, standardized component hierarchy generation process 10 may generate a new component (e.g., an “Entrée” component under the “Food” category) in response to the user-defined mapped (e.g., standardized component hierarchy generation process 10 generated new “Entrée” component in response to user-defined mapping). In some implementations, the at least a portion of the transaction data may be mapped 220 to the standardized hierarchy of components based upon, at least in part, the user-defined mapping. For example, standardized component hierarchy generation process 10 may map 220 transaction data 316 to the newly created sub-category/component “Entrée”. While an example of a “stir fry entrée dish has been provided, it will be appreciated that any transaction data that cannot be mapped to the standardized hierarchy of components may be mapped via the user-defined mapping as discussed above. In some embodiments and in response to receiving the user-defined mapping, standardized component hierarchy generation process 10 may incorporate 222 the user-defined mapping into the standardized hierarchy of components. For example, standardized component hierarchy generation process 10 may incorporate 222 the user-defined mapping (e.g., “Entrée”) into the standardized hierarchy of components to improve future mapping of transaction data.

In some implementations, standardized component hierarchy generation process 10 may adjust the mapping of transaction data over time. For example, consider transaction data related to alcohol sales. In some implementations, transaction data associated with the sale of alcoholic beverages may be unique for each bartender. For example, the amount of e.g., vodka sold versus the amount of vodka poured in drinks prepared by a first bartender may be greater than the amount of vodka sold versus the amount of vodka poured in drinks prepared by a second bartender. Over time, standardized component hierarchy generation process 10 may normalize the transaction data for the same transaction data (e.g., one vodka martini) for various conditions, servers, events, etc. (e.g., a vodka martini prepared by the first bartender includes more vodka than a vodka martini prepared by the second bartender). In some implementations and as discussed above, standardized component hierarchy generation process 10 may utilize machine-learning and/or neural networks to determine trends in the mapped transaction data to more accurately map transaction data to the standardized hierarchy of components. While an example of disparate amounts of vodka poured by various bartenders has been provided, it will be appreciated that other examples of spoilage, theft, recalled products, etc. may be used to adjust the mapping of the transaction data over time.

In some implementations, mapping 202 the transaction data from the plurality of distinct point-of-sale systems to the standardized hierarchy of components may include generating 224 a list of component pairings based upon, at least in part, the mapped transaction data of the standardized hierarchy of components. A list of component pairings may generally include any grouping of a plurality of components based upon, at least in part, the mapped transaction data. For example, suppose transaction data 318 from POS system 308 indicates a grouping of e.g., a sandwich, a side order of fries, and a drink as a menu item. In this example and from the transaction data, standardized component hierarchy generation process 10 may generate 224 a list of component pairings including e.g., a sandwich, a side order of fries, and a drink as a component pairing in the standardized hierarchy of components. Alternatively, standardized component hierarchy generation process 10 may generate the list of component pairings by adding or updating attributes of each of the e.g., sandwich, side order of fries, and drink to indicate that they are part of a component pairing. In some implementations, standardized component hierarchy generation process 10 may generate 224 a list of component pairings for products and/or services that are commonly sold in combination with each other. Suppose, for example purposes only, that transaction data 318 indicates that consumers typically purchase e.g., a fish sandwich in combination with e.g., an orange-flavored soda. While this may not be a POS system-defined grouping or pairing, standardized component hierarchy generation process 10 may generate a component pairing including sales of e.g., fish sandwiches in combination with e.g., orange-flavored soda. It will be appreciated that any component grouping or pairing may be determined by standardized component hierarchy generation process 10 and used to generate 224 a list of component pairings in the standardized hierarchy of components within the scope of the present disclosure.

In some implementations, mapping 202 the transaction data from the plurality of distinct point-of-sale systems to the standardized hierarchy of components may include generating 226 a list of links between one or more brand components and one or more cross-brand components based upon, at least in part, the mapped transaction data of the standardized hierarchy of components. A “brand” may generally include a type of product manufactured by or service provided by a particular company under a particular name and “cross-brand” may generally include a similar type of product manufactured by or service provided by another company under a different name. Suppose, for example purposes only, that transaction data 314 associated with POS system 304 includes a “Mighty Burger” and transaction data 316 associated with POS system 306 includes a “Super Burger”. In some implementations, standardized component hierarchy generation process 10 may map these distinct products to the same or similar underlying components within the standardized hierarchy of components. Accordingly, standardized component hierarchy generation process 10 may generate a link between POS system 304's “Mighty Burger” and POS system 306's “Super Burger” in the standardized hierarchy of components. In this manner, the distinct products and/or services of a plurality of POS systems may be compared and linked based on the standardized hierarchy of components.

In some implementations, mapping 202 the transaction data from the plurality of distinct point-of-sale systems to the standardized hierarchy of components may include generating 228 a plurality of catalogs based upon, at least in part, the mapped transaction data of the standardized hierarchy of components. A catalog may generally include a collection of products and/or services associated with a particular business. For example, each of POS systems 302, 304, 306, 308, 310 may include distinct menus or catalogs describing products and/or services available. However, it may not be possible, or may not be desired, to share a business menu or catalog used by a POS system. Accordingly, standardized component hierarchy generation process 10 may generate 228 a plurality of catalogs based upon, at least in part, the mapped transaction data of the standardized hierarchy of components. In some implementations, standardized component hierarchy generation process 10 may create and maintain various market, demographic, brand, business unit, meal, and/or consumer-weighted catalogs or menus. In some implementations, standardized component hierarchy generation process 10 may generate 228 catalogs for various business entities (e.g., component sellers, component purchasers, component suppliers, component distributors, etc.). In this manner, standardized component hierarchy generation process 10 may generate 228 various distinct catalogs for distinct businesses or units.

In some implementations, mapping 202 the transaction data from the plurality of distinct point-of-sale systems to the standardized hierarchy of components may include linking replacement components with a particular brand for historical comparisons. For example and in some implementations, various products and/or services may be replaced or removed from a business unit. Standardized component hierarchy generation process 10 may map transaction data from a replaced component to a replacement component to provide continuity in the mapped transaction data of the standardized hierarchy of components. In some embodiments, a replacement component may be defined as an attribute associated with the replaced component.

In some implementations, standardized component hierarchy generation process 10 may share 204 the standardized hierarchy of components, including aggregated mapped transaction data. As discussed above and in some implementations, with transaction data mapped to the standardized hierarchy of components (or to a plurality of standardized hierarchies of components), aggregated mapped transaction data may be shared.

With conventional approaches to POS systems, it may not be possible or desirable to share transaction data directly with other POS systems or other applications/systems. As will be discussed in greater detail below, by mapping the transaction data to a standardized hierarchy of components (or to a plurality of standardized hierarchies of components), distinct products and/or services may be defined as a collection of components and compared to other products and/or services or defined in different units. Accordingly, a problem resulting from the use of distinct and incompatible POS systems may be resolved by a technical solution using an unconventional approach of mapping transaction data to a standardized hierarchy of components. With the standardized hierarchy, mapped transaction data may be aggregated across distinct POS systems and shared in batches, near real time, and real time. As discussed above, “real time” may generally include sharing the transaction data while processing the transaction. In this manner, standardized component hierarchy generation process 10 may allow sharing of a standardized hierarchy of components and aggregated transaction data in up to real time (e.g., batches, near real time, real time, etc.) by mapping the transaction data to the standardized hierarchy of components such that various applications/systems may understand the aggregated mapped transaction data.

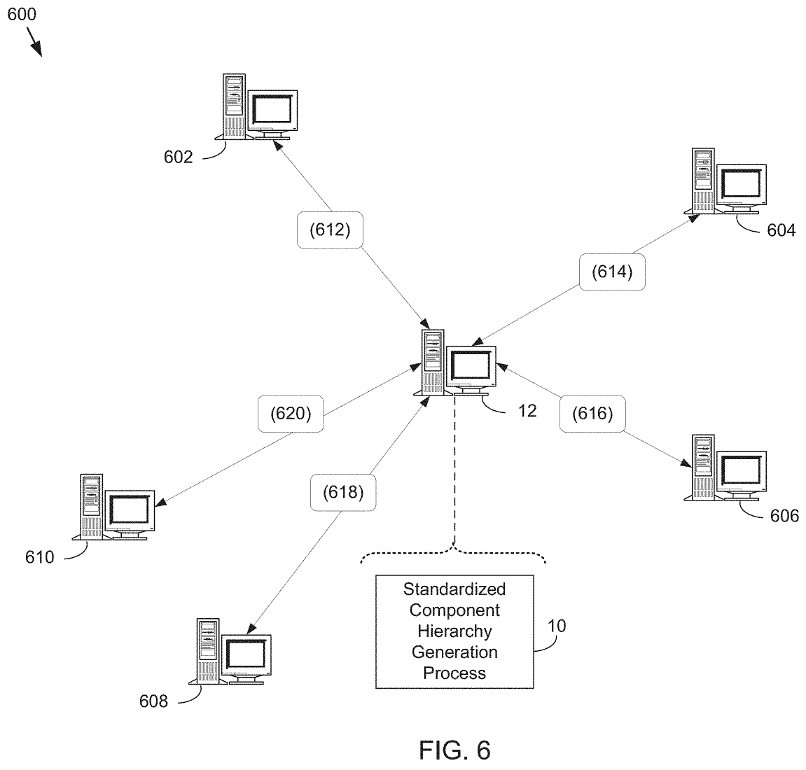

Referring also to the example of FIG. 6 and in some implementations, computing device 12 (e.g., central repository for transaction data mapped to the standardized hierarchy of components) may be communicatively coupled to a plurality of computing devices associated with a plurality of applications/systems (e.g., systems 602, 604, 606, 608, 610). In some implementations, sharing 204, in up to real time, the standardized hierarchy of components, including the aggregated mapped transaction data, may include sharing the standardized hierarchy of components, including the aggregated mapped transaction data (e.g., standardized hierarchy of components including the aggregated mapped transaction data 612, 614, 616, 618, 620), with one or more performance reporting systems; one or more ordering systems; one or more inventory systems; one or more delivery systems; and/or any third party system. In some implementations, the entirety of the standardized hierarchy of components may be shared, a portion of the standardized hierarchy of components, the entirety of the aggregated mapped transaction data may be shared, a portion of the aggregated transaction data may be shared, and/or any combination thereof may be shared by standardized component hierarchy generation process 10

In some implementations, a performance reporting system (e.g., performance reporting system 602) may generally include an application/system for receiving aggregated transaction data and, based on the shared standardized hierarchy of components, allows a user to determine performance of a products and/or services for various categories or sub-categories of the standardized hierarchy of components. In this manner, a user may select a category or sub-category of a standardized hierarchy of components and receive KPI's associated with the category or sub-category. In some implementations, the aggregated mapped transaction data may be organized in various categories not defined by, but based upon, at least in part, the standardized hierarchy of components. In this manner, the aggregated mapped transaction data and the standardized hierarchy of components may be used to derive other performance data. In some implementations, performance reporting system 604 may include business intelligence applications/systems and/or analytics applications/systems available from the Assignee of the present disclosure.

In some implementations, an ordering system (e.g., ordering system 604) may include an application/system for automating the ordering of finished products. For example, standardized component hierarchy generation process 10 may share the standardized hierarchy of components, including the aggregated mapped transaction data, with ordering system 604 to allow ordering system 604 to automatically identify needs for orders of products and to generate the orders, in nearly real time (or real time). In this manner, the sharing of the standardized hierarchy of components including the aggregated mapped transaction data allows ordering system 604 to identify components from the standardized hierarchy of components and the mapped aggregated transaction data specific to ordering system 604 for generating orders of products.

In some implementations, ordering system 606 may include an application/system to automate the ordering of raw materials and/or finished ingredients/components/subassemblies for production of finished products for resale. For example, standardized component hierarchy generation process 10 may share the standardized hierarchy of components, including the aggregated mapped transaction data, with order system 606 to allow ordering system 606 to automatically identify needs for orders of raw materials and/or finished ingredients/components/subassemblies for production of finished products and to generate the orders, in nearly real time (or real time). In this manner, the sharing of the standardized hierarchy of components including the aggregated mapped transaction data allows ordering system 606 to identify components from the standardized hierarchy of components and the mapped aggregated transaction data specific to ordering system 606 for generating orders of raw materials and/or finished ingredients/components/subassemblies for production of finished products.

In some implementations, an inventory system (e.g., inventory system 608) may generally include an application/system for managing the inventory, forecasting future need for, and/or automating the reordering of finished products and/or raw materials. For example, standardized component hierarchy generation process 10 may share the standardized hierarchy of components, including the aggregated mapped transaction data, with inventory system 608 to allow inventory system 608 to automatically update current inventory associated with a business unit, forecast a future need for various components from the standardized hierarchy of components, and/or reorder finished products and/or raw materials or near real time. In this manner, the sharing of the standardized hierarchy of components including the aggregated mapped transaction data allows inventory system 608 to identify components from the standardized hierarchy of components and the mapped aggregated transaction data specific to inventory system 608 for automatically updating current inventory associated with a business unit, forecasting a future need for various components from the standardized hierarchy of components, and/or reordering finished products and/or raw materials.

In some implementations, a delivery system (e.g., delivery system 610) may generally include an application/system for processing a purchase (e.g., online or in-store) of products and/or services and the delivery of ordered products and/or services to a purchaser. In some implementations and as discussed above, standardized component hierarchy generation process 10 may generate 226 a plurality of catalogs for various business units. In some implementations, standardized component hierarchy generation process 10 may share 204 or push the generated catalog(s) to the one or more delivery systems. For example, standardized component hierarchy generation process 10 may share 204 the standardized hierarchy of components including the generated catalog with one or more third party systems (e.g., delivery systems (e.g., UberEats®), business information sources (e.g., TripAdvisor®, Yelp®), etc.). In some implementations, standardized component hierarchy generation process 10 may share 204 e.g., new menu/catalog items to the one or more delivery systems and e.g., menu catalog organization and/or details to the one or more business information sources. As will be discussed in greater detail below and in some implementations, a POS system may determine which information (e.g., transaction data and/or portions of standardized hierarchy of components) is shared with various applications/systems.

While examples have been provided of various applications/systems that standardized component hierarchy generation process 10 may share the standardized hierarchy of components, including the aggregated mapped transaction data, with, it will be appreciated that standardized component hierarchy generation process 10 may share the standardized hierarchy of components, including the aggregated mapped transaction data, with any application/system including, but not limited to, a recipe management system (e.g., applications configured to create and maintain an ingredient menu for each product); a supply chain system (e.g., applications configured to create, transmit, track, and/or modify orders from a unit to the brand, distributor, and/or supplier for delivery to the unit, or up the chain from the brand to distributor, distributor to supplier, and/or supplier to producer); a food safety system (e.g., applications configured to maintain a chain of custody from the producer to the supplier to the distributor to the unit so as to enable notification in the event of health safety issue); a nutrition management system (e.g., applications configured to maintain, for each product, the nutritional content from producer to supplier to unit so that it can be computed and measured for various combinations of raw materials across various preparation methods); a marketing system (e.g., applications configured to import, manage, and export consumer information and present promotions to consumers via advertising, promotions, third parties, and/or at a POS system); etc.

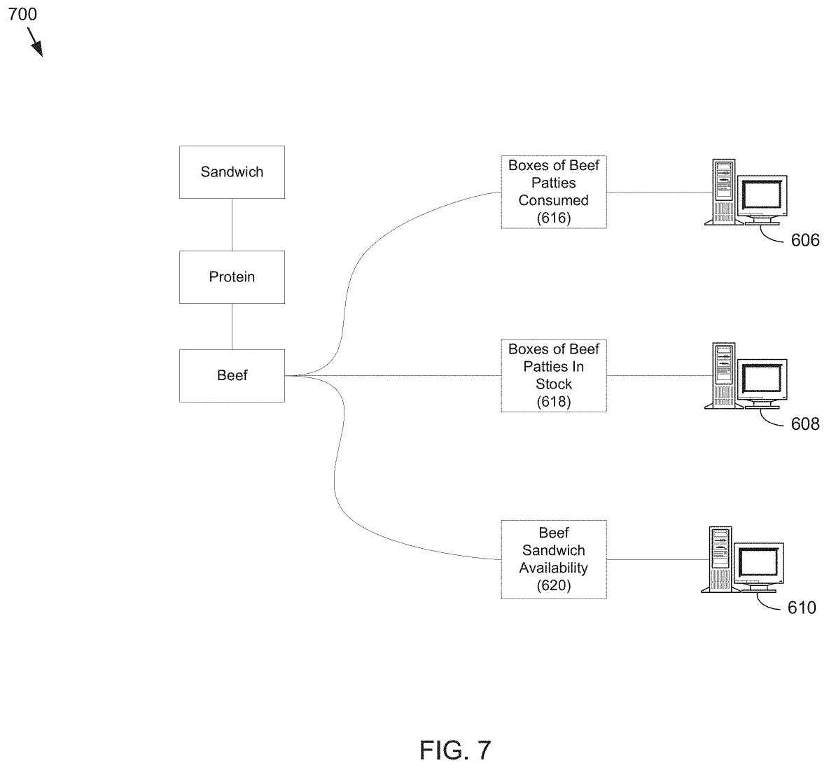

In some implementations, sharing 204 the standardized hierarchy of components, including the aggregated mapped transaction data, may include converting 230 the aggregated mapped transaction data of the standardized hierarchy of components into one or more recipient-specific formats. Referring also to the example of FIG. 7 and in some implementations, a portion of a standardized hierarchy of components is shown (e.g., components associated with a beef sandwich). In some implementations, standardized component hierarchy generation process 10 may share 204 the standardized hierarchy of components, including the aggregated mapped transaction data, with various applications and/or systems. In some implementations, standardized component hierarchy generation process 10 may convert 230 the aggregated mapped transaction data into a format specific to the recipient. For example, suppose standardized component hierarchy generation process 10 shares 204 aggregated mapped transaction data with an ordering system (e.g., ordering system 606) associated with e.g., a frozen beef patty supplier/distributer; an inventory system (e.g., inventory system 608) associated with e.g., a business inventory system of a business unit; and a delivery system (e.g., delivery system 610). In this example, standardized component hierarchy generation process 10 may convert the aggregated mapped transaction data into a recipient-specific format for each recipient.

In the example of FIG. 7, standardized component hierarchy generation process 10 may convert 230 the aggregated mapped transaction data from e.g., transaction data regarding beef sandwiches to e.g., a number of boxes of frozen beef patties consumed for ordering system 606. Similarly, standardized component hierarchy generation process 10 may convert 230 the aggregated mapped transaction data from e.g., transaction data regarding beef sandwiches to e.g., a number of frozen beef patties in stock for inventory system 608 and transaction data regarding beef sandwiches to e.g., an availability of a particular beef sandwich for delivery system 610. It will be appreciated that the mapped transaction data may be converted into any format for various recipient applications/systems within the scope of the present disclosure.

In some implementations, sharing 204 the standardized hierarchy of components, including the aggregated mapped transaction data, may include defining a security protocol for controlling access to mapped transaction data in the standardized hierarchy of components and/or portions of the standardized hierarchy of components. For example and in some implementations, a user or business unit administrator may generate an account with standardized component hierarchy generation process 10 to manage a security protocol to determine which information can be shared with various third parties. For example, a business unit may want to provide its franchise with certain access to its transaction data while not providing certain menu features from the standardized hierarchy of components. In another example and as discussed above, a business unit may want to provide or authorize sharing menu content with one or more delivery systems and/or business information sources without providing sales performance information. In some implementations, the security protocol may be defined via a user interface generated on a computing device. In some implementations, standardized component hierarchy generation process 10 may provide a default security protocol that may be modified by a user and/or business unit administrator.

In some implementations, sharing 204 the standardized hierarchy of components, including the aggregated mapped transaction data, may include providing alerts at various access levels, for new and/or discontinued menu items, changed menu prices, new or updated product promotions, products, services, brands, distributors, suppliers, etc. For example, standardized component hierarchy generation process 10 may provide an alert, based on the mapped transaction data that e.g., a soft drink company is testing a fresh juice single serve at certain business units in a particular geographic area. It will be appreciated that the alerts provided may be based upon, at least in part, the mapped transaction data, the standardized hierarchy of components, and/or any alert notification settings defined in standardized component hierarchy generation process 10 for a specific user or recipient.

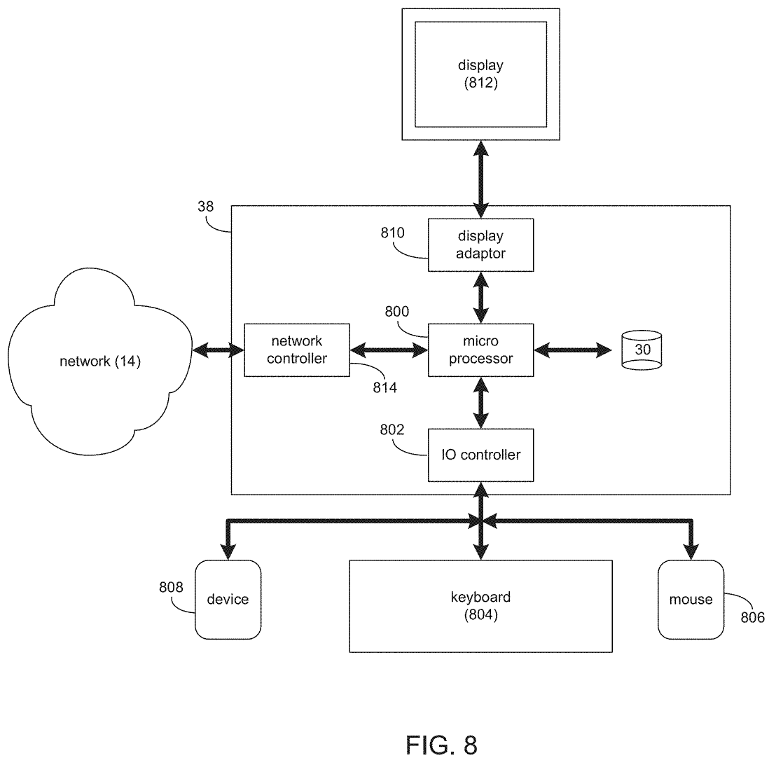

Referring also to the example implementation of FIG. 8, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, standardized component hierarchy generation process 10 may be substituted for client electronic device 38 (in whole or in part) within FIG. 8, examples of which may include but are not limited to computer 12 and/or one or more of client electronic devices 40, 42, 44.

In some implementations, client electronic device 38 may include a processor (e.g., microprocessor 800) configured to, e.g., process data and execute the above-noted code/instruction sets and subroutines. Microprocessor 800 may be coupled via a storage adaptor to the above-noted storage device(s) (e.g., storage device 30). An I/O controller (e.g., I/O controller 802) may be configured to couple microprocessor 800 with various devices (e.g., via wired or wireless connection), such as keyboard 806, pointing/selecting device (e.g., touchpad, touchscreen, mouse 808, etc.), USB ports, and printer ports. A display adaptor (e.g., display adaptor 810) may be configured to couple display 812 (e.g., touchscreen monitor(s), plasma, CRT, or LCD monitor(s), etc.) with microprocessor 800, while network controller/adaptor 814 (e.g., an Ethernet adaptor) may be configured to couple microprocessor 800 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, via a computing device, transaction data associated with a plurality of distinct point-of-sale systems;
mapping the transaction data from the plurality of distinct point-of-sale systems to a standardized hierarchy of components; and
sharing the standardized hierarchy of components, including aggregated mapped transaction data.

2. The computer-implemented method of claim 1, further comprising:
receiving attribute information associated with the transaction data.

3. The computer-implemented method of claim 1, wherein mapping the transaction data from the plurality of distinct point-of-sale systems to the standardized hierarchy of components includes at least one of:
performing correlation analysis of the transaction data to determine one or more patterns between components; and
performing textual analysis of the transaction data to determine similar components from the transaction data of the plurality of distinct point-of-sales systems based upon, at least in part, text of the transaction data.

4. The computer-implemented method of claim 1, wherein mapping the transaction data from the plurality of distinct point-of-sale systems to the standardized hierarchy of components includes:
generating a unique identifier for each component in the standardized hierarchy of components.

5. The computer-implemented method of claim 1, wherein mapping the transaction data from the plurality of distinct point-of-sale systems to the standardized hierarchy of components includes:
determining that at least a portion of the transaction data cannot be mapped to the standardized hierarchy of components;
generating an error indicating that the at least a portion of the transaction data cannot be mapped to the standardized hierarchy of components;
receiving a user-defined mapping for the at least a portion of the transaction data;
mapping the at least a portion of the transaction data to the standardized hierarchy of components based upon, at least in part, the user-defined mapping; and
incorporating the user-defined mapping into the standardized hierarchy of components.

6. The computer-implemented method of claim 1, wherein mapping the transaction data from the plurality of distinct point-of-sale systems to the standardized hierarchy of components includes:
generating a list of component pairings based upon, at least in part, the mapped transaction data of the standardized hierarchy of components.

7. The computer-implemented method of claim 1, wherein mapping the transaction data from the plurality of distinct point-of-sale systems to the standardized hierarchy of components includes:
generating a list of links between one or more brand components and one or more cross-brand components based upon, at least in part, the mapped transaction data of the standardized hierarchy of components.

8. The computer-implemented method of claim 1, wherein mapping the transaction data from the plurality of distinct point-of-sale systems to the standardized hierarchy of components includes:
generating a plurality of catalogs based upon, at least in part, the mapped transaction data of the standardized hierarchy of components.

9. The computer-implemented method of claim 1, wherein sharing the standardized hierarchy of components, including the aggregated mapped transaction data, includes sharing the standardized hierarchy of components, including the aggregated mapped transaction data, with at least one of:
one or more performance reporting systems;
one or more ordering systems;
one or more inventory systems; and
one or more delivery systems.

10. The computer-implemented method of claim 1, wherein sharing the standardized hierarchy of components, including the aggregated mapped transaction data, includes:
converting the aggregated mapped transaction data of the standardized hierarchy of components into one or more recipient-specific formats.

11. The computer-implemented method of claim 1, wherein the plurality of distinct point-of-sale systems are associated with a plurality of distinct eating and drinking businesses and the standardized hierarchy of components is a hierarchy of components associated with the plurality of distinct eating and drinking businesses.

12. A computing system including one or more processors and one or more memories configured to perform operations comprising:
receiving transaction data associated with a plurality of distinct point-of-sale systems;
mapping the transaction data from the plurality of distinct point-of-sale systems to a standardized hierarchy of components; and
sharing the standardized hierarchy of components, including aggregated mapped transaction data.

13. The computer-implemented method of claim 1, further configured to perform operations comprising:
receiving attribute information associated with the transaction data.

14. The computing system of claim 12, wherein mapping the transaction data from the plurality of distinct point-of-sale systems to the standardized hierarchy of components includes at least one of:
performing correlation analysis of the transaction data to determine one or more patterns between components; and
performing textual analysis of the transaction data to determine similar components from the transaction data of the plurality of distinct point-of-sales systems based upon, at least in part, text of the transaction data.

15. The computing system of claim 12, wherein mapping the transaction data from the plurality of distinct point-of-sale systems to the standardized hierarchy of components includes:
generating a unique identifier for each component in the standardized hierarchy of components.

16. The computing system of claim 12, wherein mapping the transaction data from the plurality of distinct point-of-sale systems to the standardized hierarchy of components includes:
determining that at least a portion of the transaction data cannot be mapped to the standardized hierarchy of components;
generating an error indicating that the at least a portion of the transaction data cannot be mapped to the standardized hierarchy of components;
receiving a user-defined mapping for the at least a portion of the transaction data;
mapping the at least a portion of the transaction data to the standardized hierarchy of components based upon, at least in part, the user-defined mapping; and
incorporating the user-defined mapping into the standardized hierarchy of components.

17. The computing system of claim 12, wherein mapping the transaction data from the plurality of distinct point-of-sale systems to the standardized hierarchy of components includes:
generating a list of component pairings based upon, at least in part, the mapped transaction data of the standardized hierarchy of components.

18. The computing system of claim 12, wherein mapping the transaction data from the plurality of distinct point-of-sale systems to the standardized hierarchy of components includes:
generating a list of links between one or more brand components and one or more cross-brand components based upon, at least in part, the mapped transaction data of the standardized hierarchy of components.

19. The computing system of claim 12, wherein sharing the standardized hierarchy of components, including the aggregated mapped transaction data, includes sharing the standardized hierarchy of components, including the aggregated mapped transaction data, with at least one of:
one or more performance reporting systems;
one or more ordering systems;
one or more inventory systems; and
one or more delivery systems.

20. The computing system of claim 12, wherein sharing the standardized hierarchy of components, including the aggregated mapped transaction data, includes:
converting the aggregated mapped transaction data of the standardized hierarchy of components into one or more recipient-specific formats.
